(19) United States
(12) Patent Application Publication
(10) Pub. No.: US 2025/0091630 A1
(43) Pub. Date: Mar. 20, 2025

(54) PAINT CART

(71) Applicant: Ballymore Company, Inc., Coatsville, PA (US)

(72) Inventors: William F Frame, Coatsville, PA (US); John Sayles, West Chester, PA (US)

(21) Appl. No.: 18/891,446

(22) Filed: Sep. 20, 2024

Related U.S. Application Data
(60) Provisional application No. 63/583,995, filed on Sep. 20, 2023.

(51) Int. Cl. B62B 3/06; B62B 3/10

(52) U.S. Cl. CPC B62B 3/0606; B62B 3/0625; B62B 3/104

(57) ABSTRACT

A paint cart having a base having wheels and a lifting mechanism to hold and raise a bucket of paint thereon off the floor. The paint cart may include a top platform attached to the base for holding tools and other materials and a hydraulic cylinder which prevents the lifting mechanism from lowering too abruptly.

### CROSS REFERENCE TO RELATED APPLICATIONS

This application also claims the benefit of U.S. Provisional Application No. 63/583,995, filed Sep. 20, 2023. The entire disclosure of which is incorporated herein by reference.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

Paint carts are useful for receiving and supporting heavy (sixty pounds or more) payloads, such as a bucket of paint for transport.

Accordingly, it would be useful to provide such a paint cart to eliminate the inconvenience and manual labor required to transport large paint buckets

### SUMMARY

The invention relates to a preferred embodiment of a paint cart having a base having wheels and a lifting mechanism to hold and raise a bucket of paint thereon off the floor. The paint cart may include a top platform attached to the base for holding tools and other materials.

In one form of the invention the lifting mechanism includes a pair of linkages and a connected bucket lift mechanism. One of the linkages may include a user foot control for raising and lowering the bucket lift mechanism. In one form of the invention the the connected bucket lift mechanism is pivotably attached to a vertical member of the base, the one linkage is pivotally attached to the base, and another linkage is pivotably attached to the one linkage and the first connected bucket lift mechanism.

In another form of the invention, the paint cart may include an hydraulic cylinder which prevents the lifting mechanism from lowering too abruptly. The hydraulic cylinder is pivotably attached to the base and the connected bucket lift mechanism.

### BRIEF DESCRIPTION OF THE DRAWINGS

The embodiments will be described in detail with reference to the following drawings in which like reference numerals refer to like elements wherein:

FIG. 1 shows a front perspective view of a paint cart in accordance with the present invention.

FIG. 2 shows a rear perspective view of the paint cart of FIG. 1.

FIGS. 3A, 3B, and 3C show various side views of the paint cart of FIG. 1 showing the paint bucket lifted in various positions.

FIGS. 4A, 4B, and 4C shows views of the linkages for raising the paint buck of the paint cart of FIG. 1.

### DETAILED DESCRIPTION

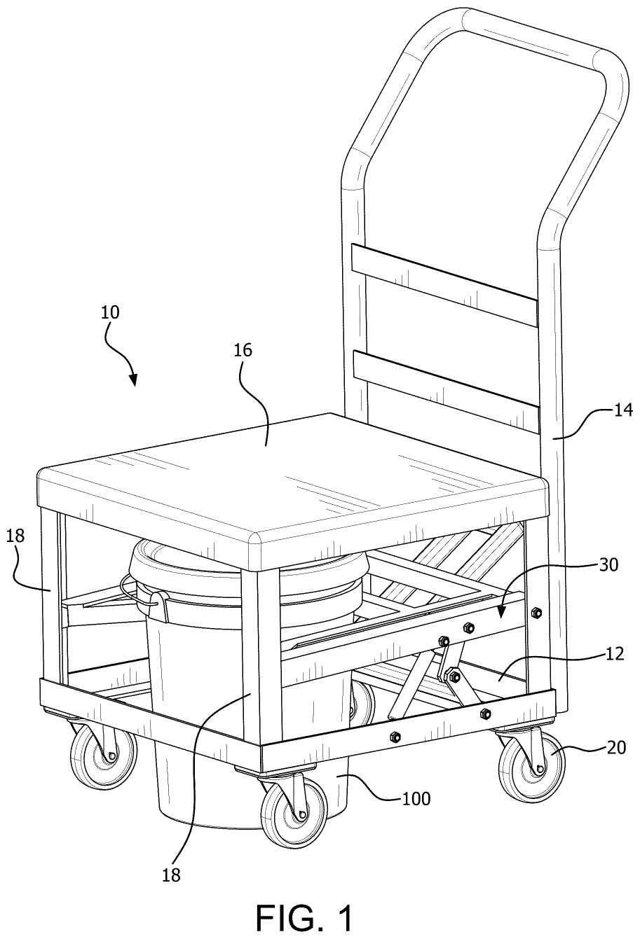

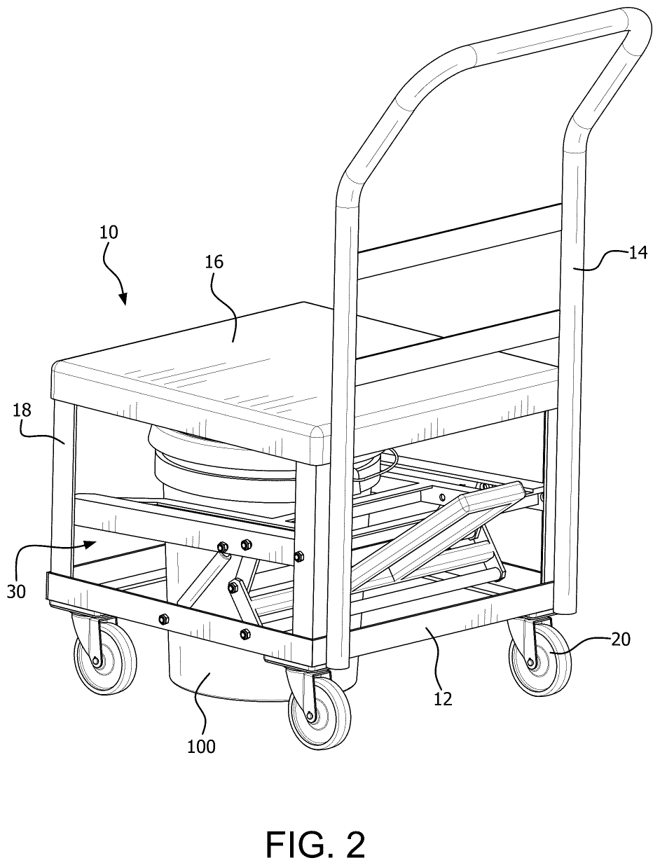

In FIGS. 1 through 4 there is shown a preferred embodiment of a paint cart 10 in accordance with the present invention.

The paint cart 10 is intended to be used to transport 60-pound 5-gallon buckets of paint 100 underneath the cart. The paint cart is not limited to carrying paint, but may be used to lift and transport any suitably sized bucket containing any material. This avoids the need to lift the paint buckets 100 for the purpose of transporting.

The paint cart 10 comprises a base 12. A handle 14. Extends upwardly from the rear of the base 12 for facilitating movement of the cart 10. Wheels 20 are provided to permit the cart 10 to be moveable. A top horizontal planar surface or deck 16 extends above the base 12 and is supported by vertical supports 18 disposed at each corner of the. The deck 16 is configured to hold paint related tools and materials or other materials thereon.

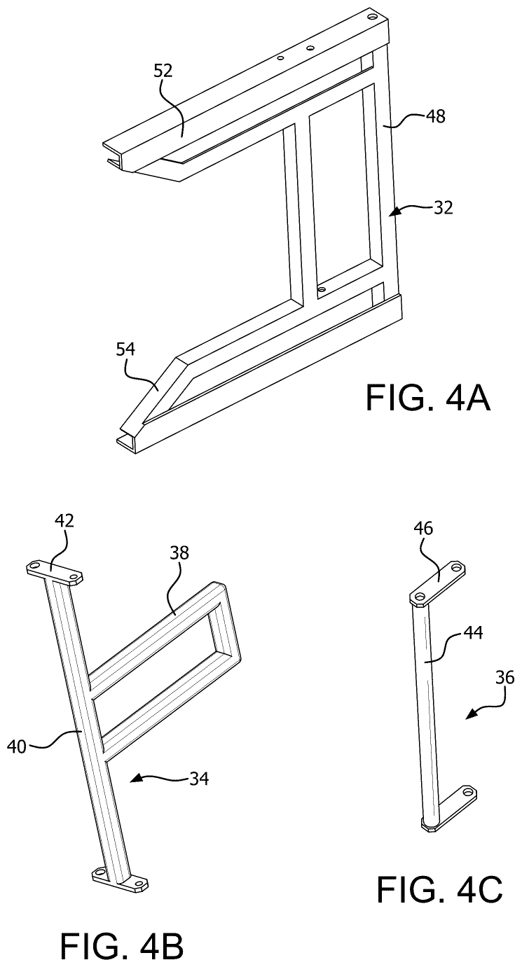

The paint cart 10 provides a lifting mechanism 30 for lifting the payload paint bucket 100 and will now be described in more detail below. The lifting mechanism 30 comprises a first lifting member 32 (FIG. 4A), a first linkage member 34 (FIG. 4B), and a second linkage member 36 (FIG. 4C).

As best seen in FIG. 4A, the first lifting member 32 is formed into a U-shape having a transverse member 48 forming the bight and a pair of legs 52 that extend therefrom. The first lifting member is sized to accept and hold the bucket 100 within the space formed by the transverse member 48 and pair of extending legs 52 as shown. The first lifting member 32 is pivotably connected at the ends of the transverse member 48 to rear vertical supports 18 of the paint cart 10. The legs 52 have an inwardly inclined face 54 to facilitate accepting the bucket 100 between the legs 52.

As best seen in FIG. 4B, the first linkage member 34 comprises a transverse member 40 and a lateral bar 42 is disposed on each end thereof and extends laterally therefrom. One end of the lateral bar 42 is pivotably attached to the base 12. A manual foot control member 38 extends from the transverse member 40 and is designed for a user to cause the lifting mechanism 30 to raise and lower.

As best seen in FIG. 4C, the second linkage member 36 comprises a transverse bar 44 and a lateral bar 46 is disposed on each end thereof. One end of the lateral bar 46 is pivotably attached to the transverse legs 52 of the first lifting member 32. The other end of each lateral bar 46 is pivotably attached to the lateral bars 42 of the first linkage member 34 at a pivot point.

A pair of hydraulic cylinders 40 have one end thereof attached to the base 12 and an other end attached to the first lifting member 32 and serve as a shock absorber as described below. The hydraulic cylinders serve as dampers that prevent the bucket from crashing to the floor when the lifting mechanism is released abruptly.

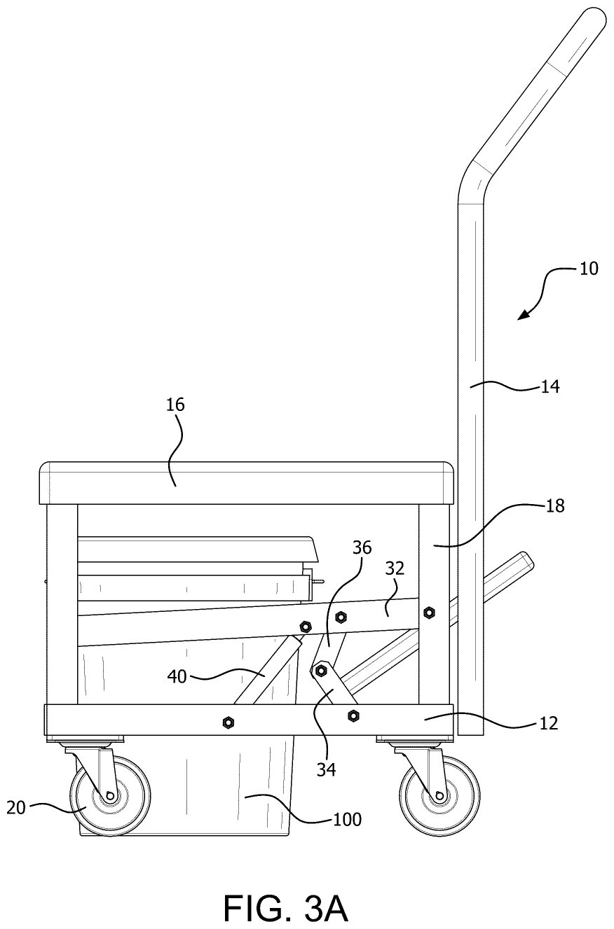

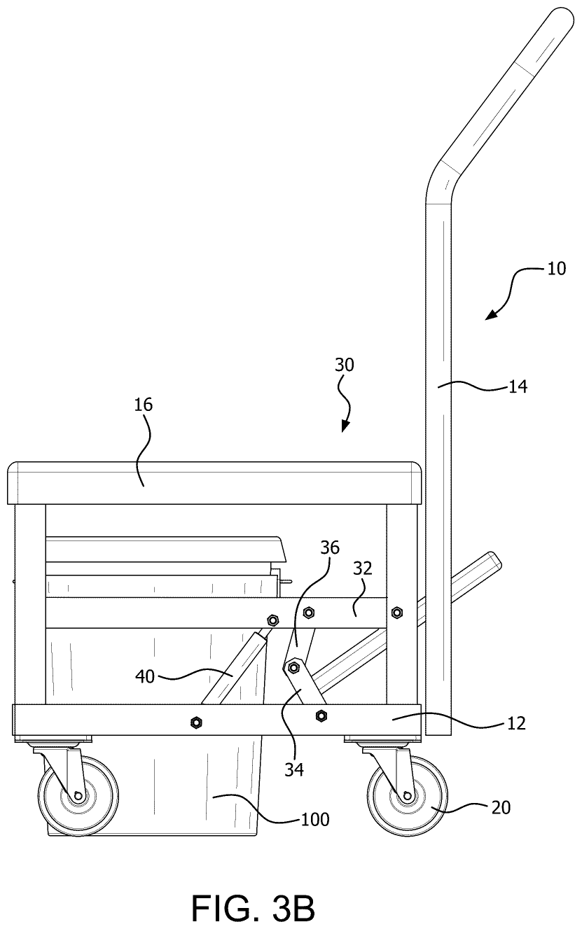

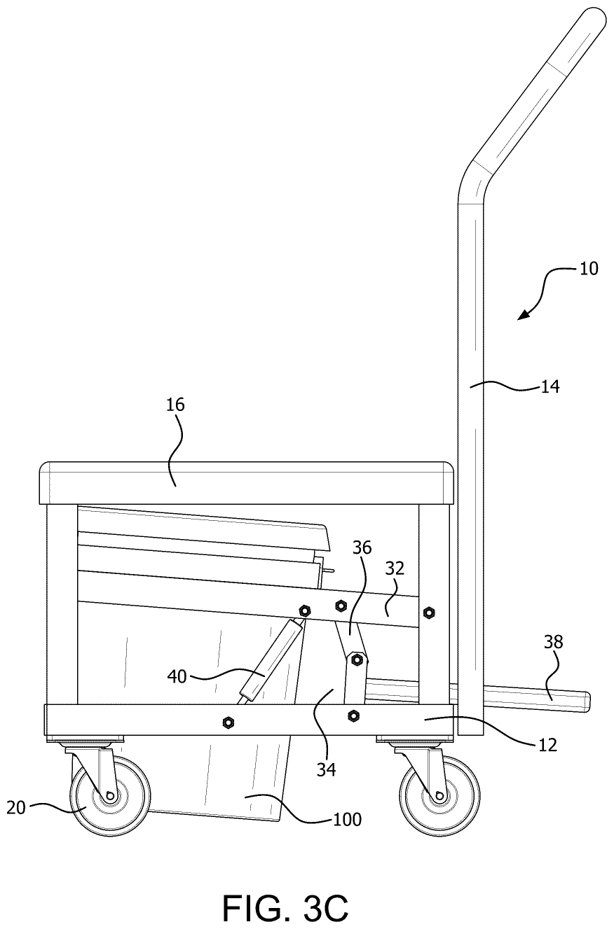

In use, a user depresses the manual foot control member 38 which pivots the first linkage member 34 rearwardly. The movement of the first linkage member 34 rearwardly rotates the second linkage member 36, raising the first lifting member 32 upwardly which holds the paint bucket 100 off the floor so the paint bucket may be moved via the paint cart 10. See FIGS. 3A-3C.

FIG. 3A shows the paint bucket 100 resting on the floor and the lifting mechanism 30 is in a lower position. In FIG. 3B the user depresses the foot control 38 which rotates the lifting mechanism 30 upwardly so that the first linkage member 34 engages the rim of the bucket 100. Further depressing the foot control 38 continues to rotate the lifting mechanism 30 upwardly so that the first linkage member 34 lifts the bucket 100 in an upper position in which the bucket 100 is lifted off the floor as best seen in FIG. 3C. The lifting mechanism 30 may be locked in this upper position if desired through a locking mechanism 60 for ease of movement.

To lower the bucket 100 from the upper to lower position, the user releases pressure on the foot control 38 which causes the lifting mechanism 30 to rotate in the opposite direction to lower the bucket. The hydraulic cylinders 40 prevent the bucket 100 from lowering the paint bucket too abruptly and prevents it from crashing to the floor and splashing.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A paint cart comprising:
a base having wheels;
a lifting mechanism to hold and raise a bucket of paint thereon off the floor.

2. The paint cart in accordance with claim 1 further comprises a top platform attached to the base for holding tools and other materials.

3. The paint cart in accordance with claim 1 wherein the lifting mechanism comprises a pair of linkages and a connected bucket lift mechanism.

4. The paint cart in accordance with claim 3, one of the linkages comprises a user foot control for raising and lowering the bucket lift mechanism.

5. The paint cart in accordance with claim 4 wherein the connected bucket lift mechanism is pivotably attached to a vertical member of the base, the one linkage is pivotally attached to the base, and an other linkage is pivotably attached to the one linkage and the first connected bucket lift mechanism.

6. The paint cart in accordance with claim 1 further comprising at least one hydraulic cylinder which prevents the lifting mechanism from lowering too abruptly.

7. The paint cart in accordance with claim 6 wherein the at least one hydraulic cylinder is pivotably attached to the base and the lifting mechanism.

8. The paint cart in accordance with claim 5 further comprising at least one hydraulic cylinder which prevents the lifting mechanism from lowering too abruptly, the at least one hydraulic cylinder is pivotably attached to the base and the connected bucket lift mechanism.
